(19) United States
(12) Patent Application Publication
(10) Pub. No.: US 2026/0121828 A1
(43) Pub. Date: Apr. 30, 2026

(54) PRIVACY-PRESERVING FEDERATED LEARNING FRAMEWORK IN RESPONSIBLE GAMING SYSTEMS

(71) Applicant: IGT, Las Vegas, NV (US)

(72) Inventors: Yizhao Zhu, Macau (CN); Wang Luen Shieh, Singapore (SG); Ka Io Leong, Macau (CN)

(21) Appl. No.: 18/925,799

(22) Filed: Oct. 24, 2024

(51) Int. Cl. H04L 9/00; G07F 17/32

(52) U.S. Cl. CPC H04L 9/008; G07F 17/3237; H04L 2209/46

(57) ABSTRACT

Embodiments of the present disclosure are directed to a privacy-preserving federated learning framework for responsible gaming systems. This framework addresses the challenges of sensitive data exchange and potential attacks on federated learning, enhancing data privacy and confidentiality in RG systems. Embodiments extend Private Set Intersection (PSI) protocols to support Labeled Private Set Intersection. This extension maintains the practical and malicious-resistant properties of the original PSI protocols.

### BACKGROUND

The present disclosure is generally directed to maintaining responsible gaming information and more particularly, to preserving privacy of responsible gaming information in a federated learning framework.

Responsible gaming (RG) promotes safe gambling practices through various strategies aimed at protecting players from the potential harms of excessive gambling. RG practices include setting gambling limits and implementing self-exclusion options. Current responsible gaming systems often rely on inflexible approaches, implementing uniform, non-adaptive gaming limits or requiring manual adjustments for individual players. This rigidity hampers real-time limit adjustments and personalized gaming experiences. Such static limits impact customer satisfaction and constrain operators' business growth potential. While machine learning offers promising solutions for creating tailored gaming limits, it introduces new challenges. The process necessitates exchanging sensitive information among various stakeholders, including casino operators, financial institutions, and third-party entities. This data sharing raises significant concerns regarding privacy and confidentiality, particularly given the sensitive nature of personal and financial data involved in the process.

### BRIEF SUMMARY

Embodiments of the present disclosure are directed to preserving privacy of responsible gaming information in a federated learning framework. According to one embodiment, a method for preserving privacy of responsible gaming information can comprise generating, by a server of a federated learning framework, a task list defining local gradient data to be provided by each responsible gaming system and/or contributor system of a plurality of responsible gaming systems and/or other contributor systems in the federated learning framework. For example, the local gradient data defined in the task list can comprise responsible gaming parameters, responsible gaming model training information, responsible gaming model tuning information, and/or other information related to responsible gaming. The task list can be published to the plurality of responsible gaming systems and/or other contributor systems in the federated learning framework.

The local gradient data defined in the task list can be received from a first responsible gaming system and/or other contributor system of the plurality of responsible gaming systems in the federated learning framework. The local gradient data can comprise gradients from a local responsible gaming model of the first responsible gaming system and/or other contributor system. The local gradient data can be received from the first responsible gaming system and/or other contributor system using Labeled Private Set Intersection (LPSI).

A global responsible gaming model can be trained using the received local gradient data and global gradient data can be generated. The global gradient data can comprise gradients from the global responsible gaming model. A request for the global gradient data can be received from a second responsible gaming system of the plurality of gaming systems and/or other contributor systems of the federated learning framework. In response to the request from the second responsible gaming system, the global gradient data can be provided to the second responsible gaming system for training a local responsible gaming model of the second responsible gaming system. The global gradient data can be provided to the second responsible gaming system using LPSI.

According to another embodiment, a system of a federated learning framework can comprise a processor and a memory coupled with and readable by the processor. The memory can store therein a set of instructions which, when executed by the processor, causes the processor to generate a task list defining local gradient data to be provided by each responsible gaming system of a plurality of responsible gaming systems in the federated learning framework and publish the task list to the plurality of responsible gaming systems and/or other contributor systems in the federated learning framework. For example, the local gradient data defined in the task list comprises responsible gaming parameters, responsible gaming model training information, responsible gaming model tuning information, and/or other information.

The instructions can further cause the processor to receive from a first responsible gaming system and/or other contributor system of the plurality of responsible gaming systems and/or other contributor systems in the federated learning framework, the local gradient data defined in the task list. The local gradient data can comprise gradients from a local responsible gaming model of the first responsible gaming system and/or other contributor system. The local gradient data can be received from the first responsible gaming system and/or other contributor system using LPSI.

The instructions can further cause the processor to train a global responsible gaming model using the received local gradient data and generate global gradient data. The global gradient data can comprise gradients from the global responsible gaming model. The instructions can further cause the processor to receive from a second responsible gaming system of the plurality of gaming system of the federated learning framework, a request for the global gradient data and provide to the second responsible gaming system, the global gradient data in response to the request from the second responsible gaming system and for training a local responsible gaming model of the second responsible gaming system. The global gradient data provided to the second responsible gaming system can be provided using LPSI.

According to yet another embodiment, a responsible gaming system can comprise a processor and a memory coupled with and readable by the processor. The memory can store therein a set of instructions which, when executed by the processor, causes the processor to receive, from a server of a federated learning framework, a task list defining local gradient data to be provided by each responsible gaming system and/or other contributor system of a plurality of responsible gaming systems and/or other contributor systems in the federated learning framework, collect the local gradient data defined in the task list, provide the collected local gradient data to the server of the federated learning network, and receive, from the server of the federated learning network, global gradient data. The local gradient data can be provided to the server of the federated learning network and the global gradient data can be received from the server of the federated learning network using LPSI.

The global gradient data can comprise, for example, responsible gaming parameters. In another example, the global gradient data can comprise responsible gaming model training information. In such cases, the instructions can further cause the processor to train a local responsible gaming model using the global gradient data. In yet another example, the global gradient data can comprise responsible gaming model tuning information. In such cases, the instructions can further cause the processor to tune a local responsible gaming model using the global gradient data.

Additional features and advantages are described herein and will be apparent from the following Description and the figures.

### BRIEF DESCRIPTION OF THE SEVERAL VIEWS OF THE DRAWINGS

FIG. 1 is a block diagram illustrating an exemplary federated learning framework in which embodiments of the present disclosure can be implemented.

FIG. 2 is a block diagram illustrating additional details of components of an exemplary federated learning framework server according to one embodiment of the present disclosure.

FIG. 3 is a block diagram illustrating additional details of components of an exemplary responsible gaming system or other contributor system of a federated learning framework according to one embodiment of the present disclosure.

FIG. 4 is a flowchart illustrating an exemplary process for preserving privacy of responsible gaming information in a federated learning framework according to one embodiment of the present disclosure.

FIG. 5 is a flowchart illustrating an exemplary process for preserving privacy of responsible gaming information in a federated learning framework according to another embodiment of the present disclosure.

### DETAILED DESCRIPTION

Embodiments of the present disclosure are directed to a privacy-preserving federated learning framework for responsible gaming systems. This framework addresses the challenges of sensitive data exchange and potential attacks on federated learning, enhancing data privacy and confidentiality in RG systems. Embodiments extend Private Set Intersection (PSI) protocols to support Labeled Private Set Intersection. This extension maintains the practical and malicious-resistant properties of the original PSI protocols.

Federated learning provides an ability to leverage data from various sectors while preserving data privacy. However, practical implementations face challenges such as model inversion attacks and membership inference attacks. Gradient information can also compromise user privacy, it is challenging to determine the intentions of the clients involved in training, and ensuring the reliability of the central server is also tricky, more than simply updating the model to safeguard user privacy is required.

PSI is a cryptographic protocol designed to allow two or more parties to compute the intersection of their private datasets without revealing any information about the items not in the intersection. Embodiments described herein utilize Labeled Private Set Intersection (LPSI) which extends the basic PSI protocol. It adds a layer of functionality by transferring associated labels or values along with the intersecting elements. Embodiments described herein are directed to addressing the limitations of existing Responsible Gaming (RG) systems by integrating LPSI into a Federated Learning framework.

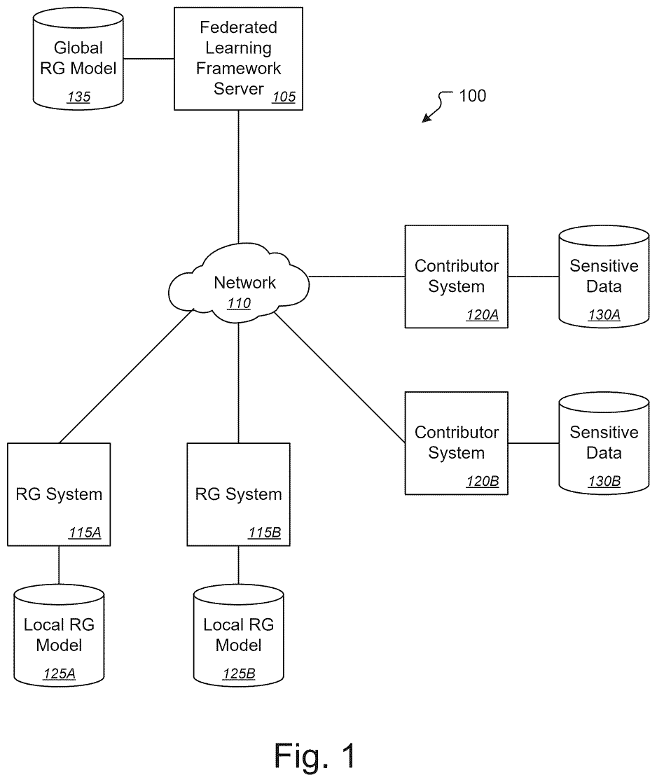

FIG. 1 is a block diagram illustrating an exemplary federated learning framework in which embodiments of the present disclosure can be implemented. As illustrated in this example, the federated learning framework 100 can comprise a server 105 coupled with a communications network 110. The server 105 of the federated learning framework 100 can comprise any one or more servers and/or other computing devices as known in the art. The communications network 110 can comprise any one or more wired and/or wireless, local-area and/or wide-area networks as known in the art including, but not limited to, the Internet.

Also coupled with the communications network can be any number of responsible gaming systems 115A-115B and any number of contributor systems 120A-120B. The responsible gaming systems 115A-115B can comprise any one or more servers and/or other computing devices as known in the art and providing responsible gaming services and functions, e.g., across various gaming systems (not shown here) in a casino or other gaming venue, based on a local responsible gaming model 125A-125B. The contributor systems 120A-120B can also comprise any one or more servers and/or other computing devices as may be utilized, for example, by various financial institutions and/or other third parties maintaining sensitive data 130A-130B that can be related to responsible gaming services or functions.

According to one embodiment, the server 105 of the federated learning framework can train a global responsible gaming model 135 across numerous client devices, i.e., the responsible gaming systems 115A-115B and contributor systems 120A-120B, with these systems processing local data and uploading only gradient information to the server 105.

More specifically, a task publisher can disseminate, through the server 105 of the federated learning framework 100, a comprehensive task list such as bet limits, loss limits, time limits, deposit limits prediction, model training, and fine-turning on existing models. This list can specify the anticipated gradients from local training data and the desired training accuracy for each task. The server 105 can utilize this detailed task list to establish communication and coordinate with each participating node, i.e., the responsible gaming systems 115A-115B and contributor systems 120A-120B, in the federated learning framework.

Each responsible gaming systems 115A-115B and contributor systems 120A-120B can upload gradient data as per the task list. LPSI can be employed to address privacy concerns during gradient sharing, preventing malicious actors from identifying the precise gradient sources. For example, a casino operators, banks, financial institutions, and third parties can act as the sender, while the server 105 can be the receiver. The privacy protection measures focus on local receiver gradient labels of the receiver from the sender and disclose only requested task-related gradients to the receiver.

The server 105 can then refine the global responsible gaming model 135 using the received gradients and compute the global gradient data. The responsible gaming systems 115A-115B can then download the global gradients data using LPSI and based on their local requirements, update local responsible gaming model 125A-125B parameters, and proceed to the next training round. In this case, the casino operators, Banks, financial institutions, and third parties can act as the receiver, while the server 105 can be the sender. The LPSI protocol can protect receiver gradient labels from senders and disclose only requested task-related gradients to the receiver. The privacy protection measures can focus on global gradient labels of the receiver from the sender, which are kept confidential from the server 105 based on local machine learning (ML) training requirements and only disclose the requested task-related gradients to the receiver.

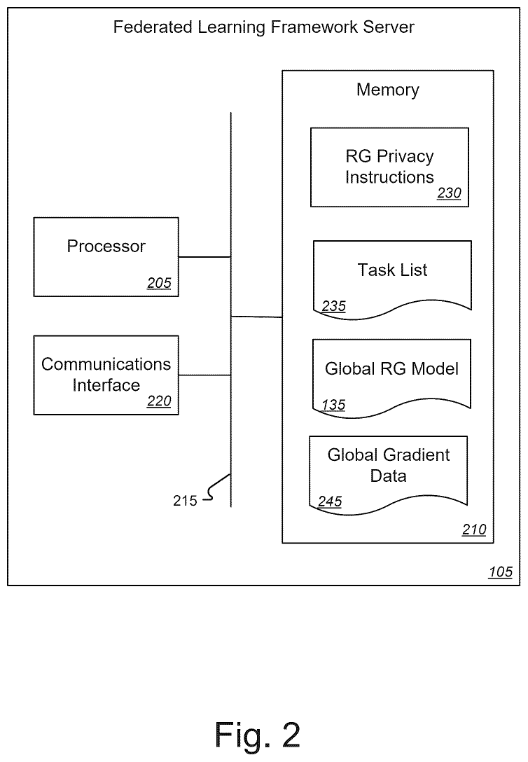

FIG. 2 is a block diagram illustrating additional details of components of an exemplary federated learning framework server according to one embodiment of the present disclosure. As illustrated in this example, a server 105 of a federated learning framework such as described above can comprise a processor 205. The processor 205 may correspond to one or many computer processing devices. For instance, the processor 205 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 205 may be provided as a microprocessor, Central Processing Unit (CPU), or plurality of microprocessors that are configured to execute the instructions sets stored in a memory 210. Upon executing the instruction sets stored in memory 210, the processor 205 enables various functions of the server 105 of the federated learning framework as described herein.

The memory 210 can be coupled with and readable by the processor 205 via a communications bus 215. The memory 210 may include any type of computer memory device or collection of computer memory devices. Non-limiting examples of memory 210 include Random Access Memory (RAM), Read Only Memory (ROM), flash memory, Electronically-Erasable Programmable ROM (EEPROM), Dynamic RAM (DRAM), etc. The memory 210 may be configured to store the instruction sets depicted in addition to temporarily storing data for the processor 205 to execute various types of routines or functions.

The processor 205 can also be coupled with one or more communication interface(s) 220 via the communications bus 215 and one or more sensors 225. The communication interface(s) 220 can comprise, for example, an Ethernet, Bluetooth, WiFi, cellular, and/or other type of wired and/or wireless communications interface. Via the communication interface(s) 220, the server 105 of the federated learning framework can communicate with other devices and/or systems through a communications network 110 as described above.

The memory 210 can store therein a set of responsible gaming privacy instructions 230 which, when executed by the processor 205, cause the processor 205 to generate a task list 235 defining local gradient data to be provided by each responsible gaming system 115A-115B and/or contributor system 120A-120B of a plurality of responsible gaming systems 115A-115B and/or contributor systems 120A-120B in the federated learning framework and publish the task list 235, e.g., through the communications interface 220, to the plurality of responsible gaming systems 115A-115B and/or other contributor systems 120A-120B in the federated learning framework. For example, the local gradient data defined in the task list 235 can comprise responsible gaming parameters, responsible gaming model training information, responsible gaming model tuning information, and/or other information.

The responsible gaming privacy instructions 230 can further cause the processor 205 to receive, e.g., through the communications interface 220, from a first responsible gaming system 115A and/or other contributor system 120A in the federated learning framework, the local gradient data defined in the task list 235. The local gradient data can comprise gradients from a local responsible gaming model of the first responsible gaming system 115A and/or other contributor system 120A. The local gradient data can be received from the first responsible gaming system 115A and/or other contributor system 120A using LPSI.

The responsible gaming privacy instructions 230 can further cause the processor 205 to train a global responsible gaming model 135 using the received local gradient data and generate global gradient data 245. The global gradient data 245 can comprise gradients from the global responsible gaming model 135. The responsible gaming privacy instructions 230 can further cause the processor 205 to receive, e.g., through the communications interface 220, from a second responsible gaming system 115B of the federated learning framework, a request for the global gradient data 245 and provide, through the communications interface 220, to the second responsible gaming system 115B, the global gradient data 245 in response to the request from the second responsible gaming system 115B and for training a local responsible gaming model 125B of the second responsible gaming system 115B. The global gradient data 245 provided to the second responsible gaming system can be provided using LPSI.

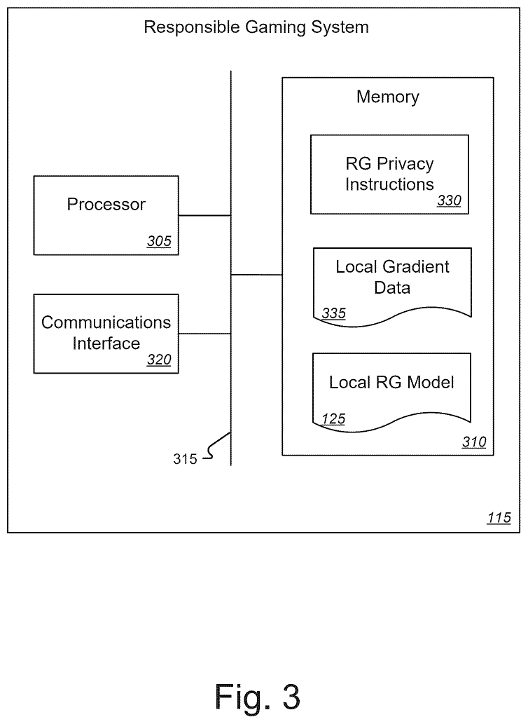

FIG. 3 is a block diagram illustrating additional details of components of an exemplary responsible gaming system or other contributor system of a federated learning framework according to one embodiment of the present disclosure. As illustrated in this example, a gaming system 115 can comprise a processor 305 such as any of the various types of processors described above. A memory 310 can be coupled with and readable by the processor 305 via a communications bus 315. The memory 310 can comprise any one or more of the different types of volatile and/or non-volatile memories described above. The processor 305 can also be coupled with one or more communication interfaces 320. The communication interfaces 320 can comprise, for example, an Ethernet, Bluetooth, WiFi, cellular, and/or other type of wired and/or wireless communications interface.

The memory 310 can store therein a set of responsible gaming privacy instructions 330 which, when executed by the processor 305, causes the processor 305 to receive, through the communications interface 220, from a server 105 of a federated learning framework, a task list 235 defining local gradient data 335 to be provided by the responsible gaming system 115 and/or other contributor system 120 of the federated learning framework, collect the local gradient data 335 defined in the task list 235, provide, through the communications interface 220 the collected local gradient data 335 to the server 105 of the federated learning network, and receive, through the communications interface 220, from the server 105 of the federated learning network, global gradient data 245. The local gradient data 335 can be provided to the server 105 of the federated learning network and the global gradient data 245 can be received from the server 105 of the federated learning network using LPSI.

The global gradient data 245 can comprise, for example, responsible gaming parameters. In another example, the global gradient data 245 can comprise responsible gaming model training information. In such cases, the responsible gaming privacy instructions 330 can further cause the processor 305 to train a local responsible gaming model 125 using the global gradient data 245. In yet another example, the global gradient data 245 can comprise responsible gaming model tuning information. In such cases, the responsible gaming privacy instructions 330 can further cause the processor 305 to tune a local responsible gaming model 125 using the global gradient data 245.

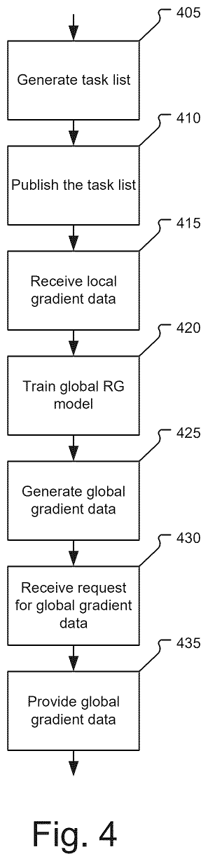

FIG. 4 is a flowchart illustrating an exemplary process for preserving privacy of responsible gaming information in a federated learning framework according to one embodiment of the present disclosure. More specifically, this example illustrates processes as may be performed by a server 105 of a federated learning framework as described above. As illustrated in this example, the process can begin with generating 405 a task list 235 defining local gradient data 335 to be provided by each responsible gaming system 115A-115B and/or contributor system 120A-120B of a plurality of responsible gaming systems 115A-115B and/or other contributor systems 120A-120B in the federated learning framework. For example, the local gradient data 335 defined in the task list 235 can comprise responsible gaming parameters, responsible gaming model training information, responsible gaming model tuning information, and/or other information related to responsible gaming. The task list 235 can be published 410 to the plurality of responsible gaming systems 115A-115B and/or other contributor systems 120A-120B in the federated learning framework.

The local gradient data 335 defined in the task list 235 can be received 415 from a first responsible gaming system 115A and/or other contributor system 120A of the plurality of responsible gaming systems 115A-115B and/or other contributor systems 1520A-120B in the federated learning framework. The local gradient data 335 can comprise gradients from a local responsible gaming model 125A of the first responsible gaming system 115A and/or other sensitive data 130A from a contributor system 120A. The local gradient data 335 can be received 415 from the first responsible gaming system 115A and/or other contributor system 120A using LPSI.

A global responsible gaming model 135 can be trained 420 using the received local gradient data 235 and global gradient data 245 can be generated 425. The global gradient data 245 can comprise gradients from the global responsible gaming model 135. A request for the global gradient data 245 can be received 430 from a second responsible gaming system 115B of the plurality of gaming systems 115A-115B of the federated learning framework. In response to the request from the second responsible gaming system 115B, the global gradient data 245 can be provided 435 to the second responsible gaming system 115B for training a local responsible gaming model 125B of the second responsible gaming system 115B. The global gradient data 245 can be provided 435 to the second responsible gaming system 115B using LPSI.

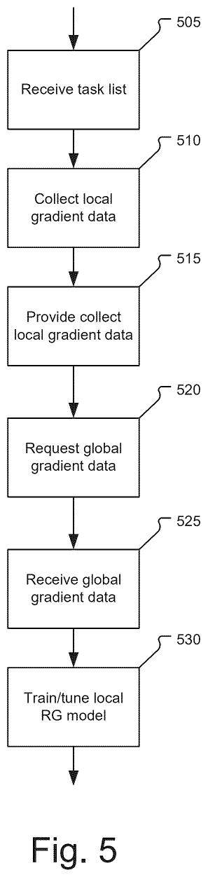

FIG. 5 is a flowchart illustrating an exemplary process for preserving privacy of responsible gaming information in a federated learning framework according to another embodiment of the present disclosure. More specifically, this example illustrates processes as may be performed by a responsible gaming system 115A or contributor system 120A of a federated learning framework as described above. As illustrated in this example, the process can begin with receiving 505, from a server 105 of a federated learning framework, a task list 235 defining local gradient data 335 to be provided by each responsible gaming system 115A-115B and/or other contributor system 120A-120B of a plurality of responsible gaming systems 115A-115B and/or other contributor systems 120A-120B in the federated learning framework, collecting 510 the local gradient data 335 defined in the task list 235, and provide 515 the collected 510 local gradient data 335 to the server 105 of the federated learning network. The local gradient data can be provided to the server of the federated learning network using LPSI.

In the case of a responsible gaming system 115A, global gradient data 245 can be requested 520 from the server 105 and the requested 520 global gradient data can be received 525 from the server 105 of the federated learning network. The global gradient data 245 can be received 525 from the server 105 of the federated learning network using LPSI. The global gradient data can comprise, for example, responsible gaming parameters. In other examples, the global gradient data can comprise responsible gaming model training information and/or responsible gaming model tuning information. In such cases, the local responsible gaming model 125 of the responsible gaming system 115A can be trained and/or tuned 530 using the global gradient data 245.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A method for preserving privacy of responsible gaming information, the method comprising:
generating, by a server of a federated learning framework, a task list defining local gradient data to be provided by each responsible gaming system of a plurality of responsible gaming systems in the federated learning framework;
publishing, by the server of a federated learning framework, the task list to the plurality of responsible gaming systems in the federated learning framework
receiving, by the server of the federated learning framework, from a first responsible gaming system of the plurality of responsible gaming systems in the federated learning framework, the local gradient data defined in the task list, the local gradient data comprising gradients from a local responsible gaming model of the first responsible gaming system;
training, by the server of the federated learning framework, a global responsible gaming model using the received local gradient data; and
generating, by the server of the federated learning framework, global gradient data comprising gradients from the global responsible gaming model.

2. The method of claim 1, wherein the local gradient data received from the first responsible gaming system is received using Labeled Private Set Intersection (LPSI).

3. The method of claim 1, further comprising:
receiving, by the server of the federated learning framework, from a second responsible gaming system of the plurality of gaming system of the federated learning framework, a request for the global gradient data; and
providing, by the server of the federated learning framework, to the second responsible gaming system, the global gradient data in response to the request from the second responsible gaming system and for training a local responsible gaming model of the second responsible gaming system.

4. The method of claim 3, wherein the global gradient data provided to the second responsible gaming system is provided using LPSI.

5. The method of claim 1, wherein the local gradient data defined in the task list comprises responsible gaming parameters.

6. The method of claim 1, wherein the local gradient data defined in the task list comprises responsible gaming model training information.

7. The method of claim 1, wherein the local gradient data defined in the task list comprises responsible gaming model tuning information.

8. A system of a federated learning framework, the system comprising:
a processor; and
a memory coupled with and readable by the processor and storing therein a set of instructions which, when executed by the processor, causes the processor to:
generate a task list defining local gradient data to be provided by each responsible gaming system of a plurality of responsible gaming systems in the federated learning framework;
publish the task list to the plurality of responsible gaming systems in the federated learning framework
receive from a first responsible gaming system of the plurality of responsible gaming systems in the federated learning framework, the local gradient data defined in the task list, the local gradient data comprising gradients from a local responsible gaming model of the first responsible gaming system;
train a global responsible gaming model using the received local gradient data; and
generate global gradient data comprising gradients from the global responsible gaming model.

9. The system of claim 8, wherein the local gradient data received from the first responsible gaming system is received using Labeled Private Set Intersection (LPSI).

10. The system of claim 8, wherein the instructions further cause the processor to:
receive from a second responsible gaming system of the plurality of gaming system of the federated learning framework, a request for the global gradient data; and
provide to the second responsible gaming system, the global gradient data in response to the request from the second responsible gaming system and for training a local responsible gaming model of the second responsible gaming system.

11. The system of claim 10, wherein the global gradient data provided to the second responsible gaming system is provided using LPSI.

12. The system of claim 8, wherein the local gradient data defined in the task list comprises responsible gaming parameters.

13. The system of claim 8, wherein the global gradient data defined in the task list comprises responsible gaming model training information.

14. The system of claim 8, wherein the global gradient data defined in the task list comprises responsible gaming model tuning information.

15. A responsible gaming system comprising:
a processor; and
a memory coupled with and readable by the processor and storing therein a set of instructions which, when executed by the processor, causes the processor to:
receive, from a server of a federated learning framework, a task list defining local gradient data to be provided by each responsible gaming system of a plurality of responsible gaming systems in the federated learning framework;
collect the local gradient data defined in the task list;
provide the collected local gradient data to the server of the federated learning network; and
receive, from the server of the federated learning network, global gradient data.

16. The responsible gaming system of claim 15, wherein the local gradient data is provided to the server of the federated learning network and the global gradient data is received from the server of the federated learning network using Labeled Private Set Intersection (LPSI).

17. The responsible gaming system of claim 15, wherein the global gradient data comprises responsible gaming parameters.

18. The responsible gaming system of claim 15, wherein the global gradient data comprises responsible gaming model training information.

19. The responsible gaming system of claim 18, wherein the instructions further cause the processor to train a local responsible gaming model using the global gradient data.

20. The responsible gaming system of claim 15, wherein the global gradient data comprises responsible gaming model tuning information and wherein the instructions further cause the processor to tune a local responsible gaming model using the global gradient data.
